(19) United States
(12) Patent Application Publication
(10) Pub. No.: US 2013/0075621 A1
(43) Pub. Date: Mar. 28, 2013

(54) RADIATION DETECTION APPARATUS AND DETECTION SYSTEM INCLUDING SAME

(71) Applicants: Minoru Watanabe, Honjo-shi (JP); Chiori Mochizuki, Sagamihara-shi (JP); Keigo Yokoyama, Honjo-shi (JP); Masato Ofuji, Honjo-shi (JP); Jun Kawanabe, Kodama-gun (JP); Kentaro Fujiyoshi, Kumagaya-shi (JP); Hiroshi Wayama, Honjo-shi (JP)

(72) Inventors: Minoru Watanabe, Honjo-shi (JP); Chiori Mochizuki, Sagamihara-shi (JP); Keigo Yokoyama, Honjo-shi (JP); Masato Ofuji, Honjo-shi (JP); Jun Kawanabe, Kodama-gun (JP); Kentaro Fujiyoshi, Kumagaya-shi (JP); Hiroshi Wayama, Honjo-shi (JP)

(73) Assignee: CANON KABUSHIKI KAISHA, Tokyo (JP)

(21) Appl. No.: 13/609,755

(22) Filed: Sep. 11, 2012

(30) Foreign Application Priority Data
Sep. 22, 2011 (JP) 2011-207348

(51) Int. Cl. G01T 1/17

(52) U.S. Cl. 250/394; 250/336.1

(57) ABSTRACT

A detection apparatus includes a conversion element; a transistor which includes a semiconductor layer including a first channel region and a second channel region, a first gate electrode, and a second gate electrode; a first drive wiring which is connected to the first gate electrode; a second drive wiring which is connected to the second gate electrode; a first conduction voltage supply unit which supplies the first conduction voltage to the first driving wiring; a second conduction voltage supply unit which supplies the second conduction voltage to the second driving wiring; and a selection unit which selects any one of a first connection between the second drive wiring and the first conduction voltage supply unit and a second connection between the second drive wiring and the second conduction voltage supply unit.

### BACKGROUND OF THE INVENTION

1. Field of the Invention

The present invention relates to a radiation detection apparatus and a detection system including the apparatus, which may be useful as a medical image diagnostic apparatus, a non-destructive testing apparatus, an analyzing apparatus using radiation, or the like.

2. Description of the Related Art

A thin-film semiconductor manufacturing technique is used in the manufacture of a detection apparatus such as a photo detection apparatus or a radiation detection apparatus having an array of pixels (a pixel array). The thin-film semiconductor manufacturing technique allows for efficient fabrication of the pixel array by combining a switch element such as a thin film transistor (hereinafter, referred to as a TFT) and a conversion element such as a photoelectric conversion element to form each pixel. In recent years, as result of the thin-film semiconductor manufacturing technique, a radiation detection apparatus, which can handle a plurality of imaging modes such as dynamic (fluoroscopic) imaging, general (still) imaging, and the like, has been disclosed.

Generally, since a radiation detection apparatus (detection apparatus) mainly needs high-speed operability in the fluoroscopic imaging mode and, the detection apparatus mainly needs a high signal-to-noise (S/N) ratio in the still imaging mode, a detection apparatus which can handle a plurality of photographing modes needs both high-speed operability and high S/N ratio. Especially, in a large area detection apparatus in about an X-ray film size using thin film transistors (TFT), since a drive wiring for driving the TFT or a signal wiring for transmitting a signal from the TFT is long, wiring capacitance of the drive wiring or the signal wiring may increase. When the wiring capacitance of the drive wiring or the signal wiring increases, transmission delay of the signal in the drive wiring or the signal wiring may increase. Thus, in the large area detection apparatus using the TFT, the realization of high-speed operability is an important issue. The increase of the wiring capacitance of the signal wiring increases noise, and the S/N ratio maybe largely decreased. In addition, a leak current is present in the TFT at an off time, and the S/N ratio may be decreased. Accordingly, in the large area detection apparatus using TFTs, securing a high S/N ratio is also an important issue. Thus, to appropriately handle a plurality of imaging modes with a large area detection apparatus using TFTs, ensuring both high-speed operability and high S/N ratio is highly desirable.

United States Patent Application Publication No. 2006/0249763, disclosed by the Assignee of the present application (Canon Kabushiki Kaisha), discusses a detection apparatus including pixels formed of a TFT to which a conversion element is connected. United States Patent Application Publication No. 2006/0249763 discusses using a polycrystalline semiconductor layer as the TFT, which provides high-speed operability. United States Patent Application Publication No. 2006/0249763 further discusses to use a TFT including a plurality of gate electrodes, i.e. a TFT with a multi-gate structure, which are commonly connected to a drive wiring. Thus, a leakage current of the TFT is suppressed and the S/N ratio is improved.

United States Patent Application Publication No. 2011/0006191, also disclosed by the Assignee of the present application, discusses a detection apparatus which includes a plurality of pixels each having a plurality of TFTs with different operating resistances and a conversion element, a selection unit for selecting at least one of the plurality of TFTs, and a signal wiring which outputs a signal via the selected TFT. In a photographing mode, in which high-speed operability is required, a signal is output to the signal wiring using a TFT having low operating resistance. Meanwhile, in a photographing mode, in which a high S/N ratio is required, a signal is output to the signal wiring using a TFT having high operating resistance, in other words, low leakage. Thus, the large area detection apparatus using the TFT applicable to a plurality of photographing modes discussed in United States Patent Application Publication No. 2011/0006191 ensures both of the high-speed operability and the high S/N ratio.

In the detection apparatus discussed in United States Patent Application Publication No. 2006/0249763, one drive wiring is commonly connected to one row of the TFT with a multi-gate structure, in which the drive wiring capacitance is not decreased and there is room for research into high-speed operability. In addition, the signal wiring capacitance is not decreased, and noise cannot be suppressed, thus there is room for research into the requirement of a high S/N ratio. In the detection apparatus discussed in United States Patent Application Publication No. 2011/0006191, since the number of TFTs connected to the signal wiring is large, the signal wiring capacitance is not suppressed, and noise cannot be suppressed, thus there is room for research into the requirement of a high S/N ratio. In addition, the drive wiring capacitance is not decreases, and there is room for research into it.

### SUMMARY OF THE INVENTION

The exemplary embodiments of present invention are directed to a detection apparatus which can handle a plurality of photographing modes and can ensure both high-speed operability and high S/N ratio by reducing capacitance of a drive wiring and a signal wiring connected to a transistor.

According to at least one embodiment disclosed herein, a detection apparatus includes a conversion element configured to convert radiation or light into an electric charge, a transistor configured to output an electric signal to a signal wiring according to the electric charge, the transistor including a first region connected to the conversion element, a second region connected to the signal wiring, a first channel region disposed between the first region and the second region, a second channel region disposed between the first region and the first channel region, a first gate electrode which corresponds to the first channel region, and a second gate electrode which corresponds to the second channel region, a first drive wiring connected to the first gate electrode, a second drive wiring connected to the second gate electrode, a first conduction voltage supply unit configured to supply a first conduction voltage allowing the first channel region to be in a conductive state to the first driving wiring, a second conduction voltage supply unit configured to supply a second conduction voltage allowing the second channel region to be in a conductive state to the second driving wiring, and a selection unit configured to select anyone of a first connection between the second drive wiring and the first conduction voltage supply unit and a second connection between the second drive wiring and the second conduction voltage supply unit.

Accordingly, the exemplary embodiments disclosed herein provide a detection apparatus which is applicable to a plurality of photographing modes and which can suppress an increase of capacitance of a drive wiring and a signal wiring connected to a transistor, thereby ensuring both of high-speed operability and high S/N ratio.

Further features and aspects will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1A schematically illustrates an equivalent circuit of a detection apparatus according to a first exemplary embodiment, and FIG. 1B illustrates a plan view of one pixel.

FIG. 2A is a cross-sectional view taken along a line A-A′ in FIG. 1B, and FIG. 2B is a cross-sectional view taken along a line B-B′ in FIG. 1B.

FIG. 3 is a timing chart for describing operations of the detection apparatus according to the first exemplary embodiment.

FIG. 4A is a plan view of one pixel of a detection apparatus according to a second exemplary embodiment, and FIG. 4B is a cross-sectional view of one pixel of the detection apparatus according to the second exemplary embodiment.

FIG. 5A schematically illustrates an equivalent circuit of a detection apparatus according to a third exemplary embodiment, and FIG. 5B is a plan view of one pixel of the detection apparatus according to the third exemplary embodiment.

FIG. 6 is a timing chart for describing operations of the detection apparatus according to the third exemplary embodiment.

FIG. 7 is a conceptual view of a radiation detection system using a detection apparatus.

### DESCRIPTION OF THE EMBODIMENTS

Various exemplary embodiments, features, and aspects of the invention will be described in detail below with reference to the drawings.

In the present specification, radiation includes not only α rays, β rays, γ rays, and the like, which are beams produced by a particle (including a photon) released due to radioactive decay, but also beams including energy of the same level or more, for example, X-rays, particle beams, cosmic rays, and the like.

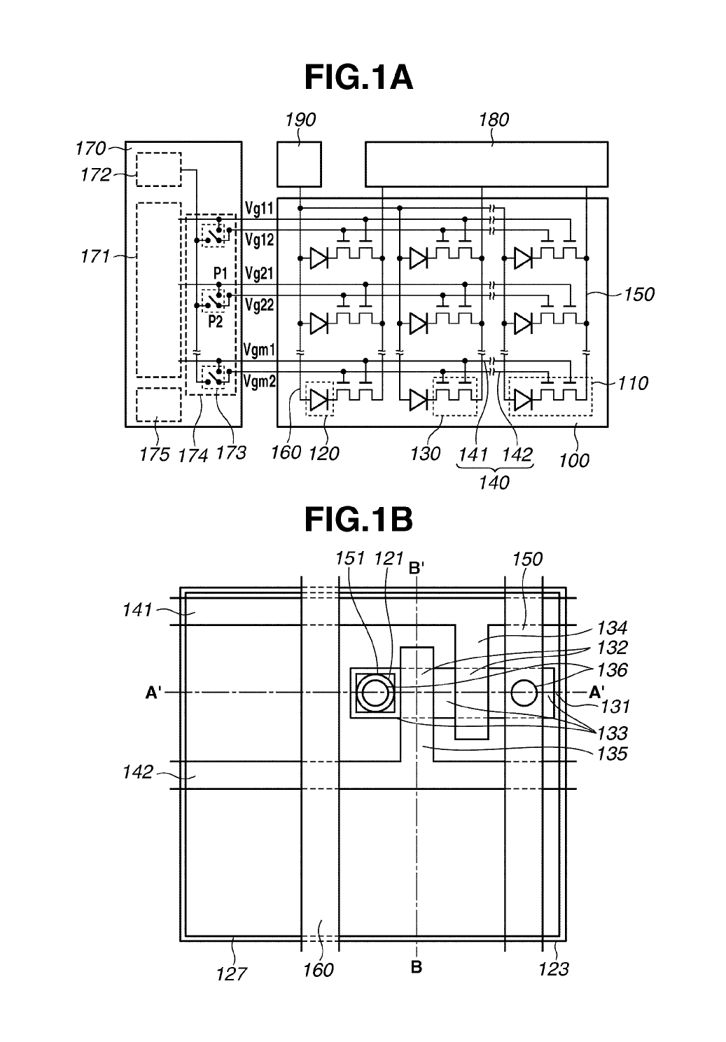

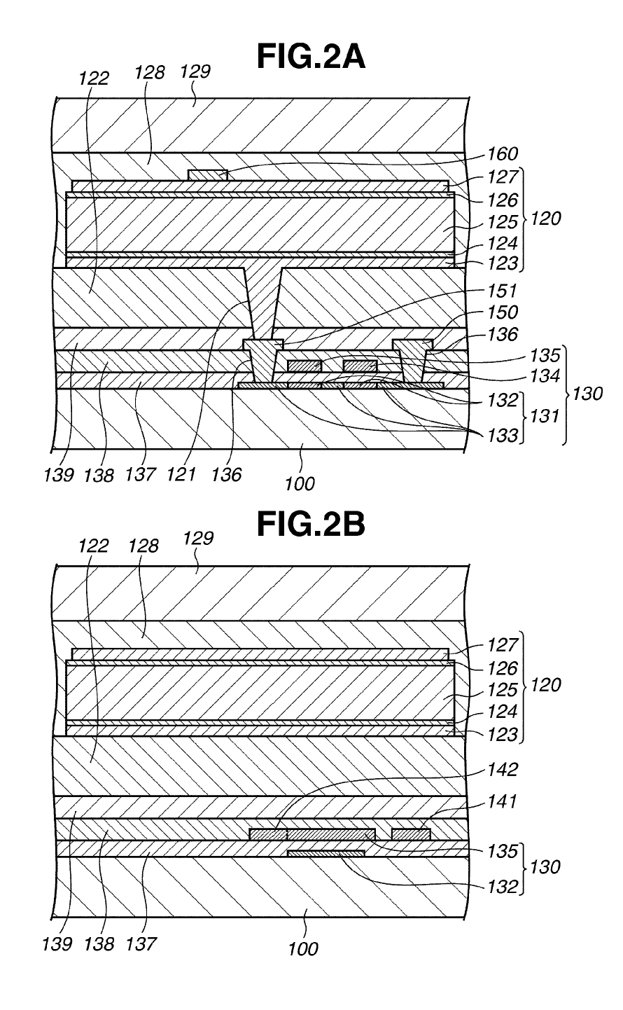

A detection apparatus according to a first exemplary embodiment is described with reference to FIGS. 1A, 1B, 2A and 2B. FIG. 1A schematically illustrates an equivalent circuit of the detection apparatus according to the first exemplary embodiment, and FIG. 1B illustrates a plan view of one pixel. In FIG. 1B, only a first electrode 123 and a second electrode 127 are illustrated in a conversion element 120 for ease of illustration. FIG. 2A is a cross-sectional view taken along a line A-A′ in FIG. 1B, and FIG. 2B is a cross-sectional view taken along a line B-B′ in FIG. 1B.

The detection apparatus includes a pixel array in which a plurality of pixels 110 is arranged in a matrix or rows and columns disposed on an insulating substrate 100. In the present exemplary embodiment, the pixel array has m rows and n columns. The pixel 110 includes a conversion element 120 for converting radiation or light into an electric charge, and a thin film transistor (TFT) 130 which outputs an electric signal according to the converted electric charge.

As illustrated in FIGS. 2A and 2B, the conversion element 120 according to the present exemplary embodiment includes a first electrode 123, a first conductive-type impurity semiconductor layer 124, an intrinsic semiconductor layer 125, a second conductive-type impurity semiconductor layer 126 having an opposite polarity to the first conductive-type impurity semiconductor layer 124, and a second electrode 127, in this order from the side of the insulating substrate 100.

The first electrode 123 of the conversion element 120 is electrically connected to an impurity semiconductor region 133 via a connection electrode 151 in contact holes 121 and 136. The impurity semiconductor region 133 is one of a source and a drain of the TFT 130. The contact hole 136 is provided in a first insulating layer 137 covering a semiconductor layer 131 of the TFT 130 and in a second insulating layer 138 covering a first gate electrode 134 and a second gate electrode 135. The contact hole 121 is provided in a third insulating layer 139 covering the connection electrode 151 and a signal wiring 150 and in a fourth insulating layer 122. The impurity semiconductor region 133, which is connected to the first electrode 123 of the conversion element 120, is referred to as a “first region” or may also be referred to as a “first semiconductor region”. The second electrode 127 of a conversion element 111 is electrically connected to an electrode wiring 160.

A fifth insulating layer 128 and a sixth insulating layer 129 are provided to cover the conversion element 120 and the electrode wiring 160. According to the present exemplary embodiment, since the conversion element 120 uses a PIN-type photodiode as a photo-electric conversion element which converts light into an electric charge, when the conversion element 120 is used as a conversion element which converts the radiation into an electric charge, a scintillator (not illustrated) is disposed on the sixth insulating layer 129. The scintillator converts a wavelength of radiation into a wavelength of light having a wavelength band which can be detected by the photo-electric conversion element. The electrode wiring 160 is connected to a power supply unit 190.

The impurity semiconductor region 133, which is the other of the source and the drain of the TFT 130, is electrically connected to the signal wiring 150 in the contact hole 136. The impurity semiconductor region 133, which is connected to the signal wiring 150, is referred to as a “second region” or may also be referred to as a “second semiconductor region”. A plurality (n pieces) of the signal wirings 150 is disposed in the row direction. Each of the signal wirings 150 is commonly connected to the other of the source and the drain of a plurality of TFTs 130 arranged in the column direction and is connected to a reading circuit unit 180 at every row.

The TFT 130 includes a semiconductor layer 131 disposed on the insulating substrate 100. The semiconductor layer 131 includes a plurality of channel regions 132 between two impurity semiconductor regions 133 (between the first region and the second region). Among the plurality of channel regions 132, a region disposed nearest to the impurity semiconductor region 133 (the second region) which is connected to the signal wiring 150 is defined as a first channel region. A region disposed between the impurity semiconductor region 133 (the first region) which is connected to the first electrode 123 and the first channel region is defined as a second channel region. According to the present exemplary embodiment, the polycrystalline semiconductor layer such as polycrystalline silicon is used as the semiconductor layer 131. The semiconductor layer 131 also includes the impurity semiconductor region 133.

The TFT 130 includes the first gate electrode 134 corresponding to the first channel region and the second gate electrode 135 corresponding to the second channel region via the first insulating layer 137 covering the semiconductor layer 131. In other words, the TFT 130 is a TFT with a multi-gate structure. By using the TFT with the multi-gate structure, an apparent channel length L of the TFT can be large, a voltage applied to each of the channel regions can be reduced, and the leakage current at off time can be reduced compared to a TFT with a single-gate structure. Further, since the TFT has the multi-gate structure and the connection to the signal wiring is one point, signal wiring capacitance can be reduced and the noise can be suppressed compared to the configuration discussed in United States Patent Application Publication No. 2011/0006191.

A drive wiring 140 of the detection apparatus includes a first drive wiring 141 connecting to the first gate electrode 134 and a second drive wiring 142 connecting to the second gate electrode 135. The first drive wiring 141 is commonly connected to the first gate electrode 134 of the TFT 130 of the plurality of pixels 110 in the row direction, and is disposed in a plural number (m pieces) in the column direction. The second drive wiring 142 is commonly connected to the second gate electrode 135 of the TFT 130 of the plurality of pixels 110 in the row direction, and is disposed in a plural number (m pieces) in the column direction. According to the above-described configuration, the capacitance of the first drive wiring 141 and the second drive wiring 142 can be reduced and decrease in high-speed operability due to the signal delay by the drive wiring can be suppressed compared to the configuration discussed in United States Patent Application Publication No. 2006/0249763.

The detection apparatus includes a driving circuit unit 170. The driving circuit unit 170 includes a first conduction voltage supply unit 171 which supplies a first driving signal including a first conduction voltage, which allows the first channel region to be in a conductive state to the first gate electrode 134 via the first drive wiring 141, and a non-conductive voltage, which allows the first channel region to be in a non-conductive state. The driving circuit unit 170 also includes a second conduction voltage supply unit 172 which supplies a second driving signal including a second conduction voltage, which allows the second channel region to be in the conductive state to the second gate electrode 135 via the second drive wiring 142.

The driving circuit unit 170 further includes a selection unit 174. The selection unit 174 includes a plurality of switches 173, each is provided by making a pair with the second drive wiring 142. The switch 173 selects any one of a first connection between the second drive wiring 142 and the first conduction voltage supply unit 171, and a second connection between the second drive wiring 142 and the second conduction voltage supply unit 172. A control unit 175 controls the selection unit 174 to select any one of the first connection and the second connection according to a plurality of photographing modes.

When the switch element 173 selects the second connection, supply of the first conduction voltage to the first gate electrode 134 by the first conduction voltage supply unit 171 and supply of the second conduction voltage to the second gate electrode 135 by the second conduction voltage supply unit 172 are performed with different timing. Especially, during a period when the second conduction voltage supply unit 172 supplies the second conduction voltage, the first conduction voltage supply unit 171 starts the supply of the first conduction voltage. Accordingly, the capacitance of the TFT 130 related to a time constant when an electric signal is output from the pixel can be reduced by an amount related to the second channel region. Thus, the high-speed operability further improves. Before starting the conduction of the first channel region, the conduction voltage is not added to the capacitance of the signal wiring 150 if the second channel region is conductive state, thus the capacitance of the signal wiring 150 does not increase and the high S/N can be obtained.

However, when the first conduction voltage supply unit 171 supplies the non-conductive voltage, the second conduction voltage supply unit 172 supplies the second conduction voltage so that the practical channel length decreases by as much as the second channel region. Thus, with respect to the suppression of the leakage current, it is unfavorable that the time required for outputting an electric signal of the entire pixel array (hereinafter, referred to as one frame time) becomes long. The leakage current does not become an issue in an operating mode of a relatively short time such as 0.015 to 0.03 seconds of the one frame time, for example, in a moving image photographing mode such as fluoroscopic photographing. In other words, if a plurality of photographing modes include a first photographing mode and a second photographing mode, and when an operating speed required for the TFT 130 in the second photographing mode is higher than that in the first photographing mode, it is desirable that the second connection is selected in the second photographing mode. The moving image photographing mode such as the fluoroscopic photographing is equivalent to the second photographing mode.

When the switch element 173 selects the first connection, the first conduction voltage is supplied from the first conduction voltage supply unit 171 to the first gate electrode 134 and the second gate electrode 135 in the same timing. Accordingly, the high-speed operability is inferior compared to the case where the second connection is selected, however, suppression of the leakage current improves, when the non-conductive voltage is supplied. Thus, it is desirable that the first connection is selected especially in the operating mode of a relatively long time such as 0.3 to 1.0 seconds of the one frame time, for example, in the general photographing (still image photographing) mode. In other words, if the plurality of photographing modes include the first photographing mode and the second photographing mode, and when the operating speed required for the TFT 130 in the second photographing mode is higher than that in the first photographing mode, it is desirable that the first connection is selected in the first photographing mode. The general photographing (still image photographing) mode is equivalent to the first photographing mode.

According to the present exemplary embodiment, an indirect-type conversion element is used including the scintillator for converting radiation into light and the PIN-type photodiode for converting light into an electric charge as the conversion element 120, however, those of ordinary skill in the art will understand that the disclosure herein is not limited to the configuration. A metal-insulator-semiconductor (MIS) type photo-electric conversion element may be used instead of the PIN-type photodiode. As the conversion element 120, a direct-type conversion element may be used which directly converts radiation into an electric charge.

According to the exemplary embodiment, the polycrystalline silicon TFT with the top gate structure is used as the TFT 130. However, amorphous silicon TFT, an oxide TFT using an oxide semiconductor, and an organic TFT using an organic semiconductor, or other equivalent structure may also be used. However, when high-speed operability is further required, anyone of the polycrystalline silicon TFT, the oxide TFT and the organic TFT is further desirable. Further, according to the exemplary embodiment, the transistor is used in which the semiconductor layer includes the first channel region and the second channel region. However, a configuration separately having a semiconductor layer including the second channel region from the semiconductor layer including the first channel region may also be feasible.

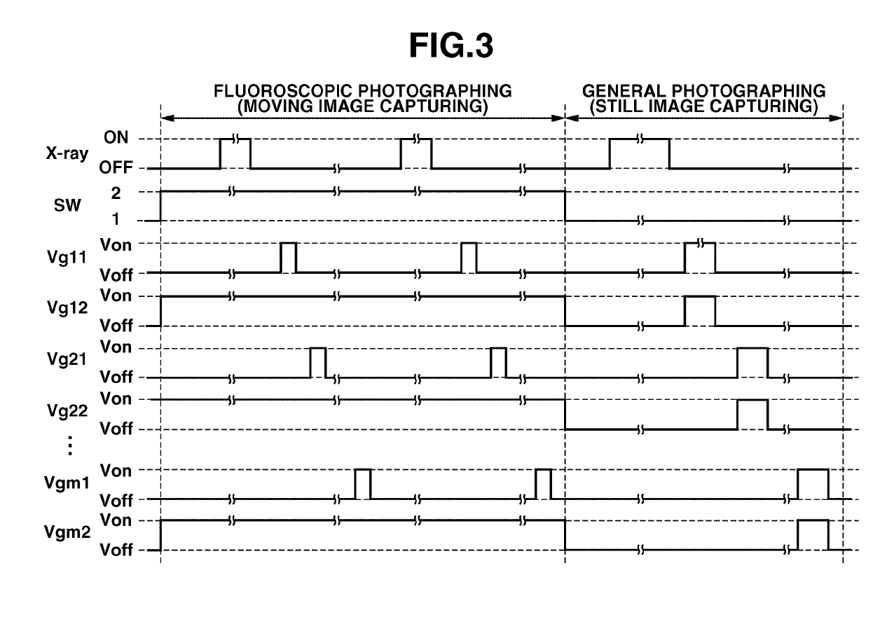

Next, operations of the detection apparatus illustrated in FIGS. 1A and 1B is described with reference to a timing chart in FIG. 3. Here, description is given as the first conduction voltage and the second conduction voltage having the same conduction voltage value Von and the same non-conductive voltage value Voff.

When the fluoroscopic photographing mode (moving image photographing mode) is selected, the control unit 175 supplies a control signal to the selection unit 174 so that the switch 173 of the selection unit 174 selects the second connection. Accordingly, the switch 173 of the selection unit 174 selects the second connection and starts the supply of the second conduction voltage from the second conduction voltage supply unit 172 to the second drive wiring 142. Then, potentials Vg12, Vg22, . . . , Vgm2 of each second drive wiring 142 become the second conduction voltage Von, and the second channel region of each TFT 130 becomes the conductive state. The above is a first process.

Next, the detection apparatus is irradiated with the radiation for a predetermined period. The electric signal is accumulated corresponding to the electric charge which is generated according to the radiation with which each pixel is irradiated. Thus, the first conduction voltage Von is sequentially supplied from the first conduction voltage supply unit 171 to each first drive wiring 141. Accordingly, potentials Vg11, Vg21, . . . , Vgm1 of each first drive wiring 141 become the first conduction voltage Von, and the first channel region of each TFT 130 sequentially becomes the conductive state by a row unit. Thus, the electric signal accumulated in the pixel 110 is sequentially output by the row unit as a parallel electric signal from the pixel 110 of the row unit to the reading circuit unit 180 via the signal wiring 150. The above is a second process. In the second process, according to the present exemplary embodiment, the supply of the second conduction voltage from the second conduction voltage supply unit 172 to the second drive wiring 142 is maintained during the fluoroscopic photographing mode (moving image photographing mode). In the fluoroscopic photographing mode (moving image photographing mode), the second process is repeatedly performed several times.

Next, when the general photographing mode (still image photographing mode) is selected, the control unit 175 supplies a control signal to the selection unit 174 so that the switch 173 of the selection unit 174 selects the first connection. Accordingly, the switch 173 of the selection unit 174 selects the first connection. Then, the potentials Vg12, Vg22, . . . , Vgm2 of each second drive wiring 142 become the non-conductive voltage Voff supplied from the first conduction voltage supply unit 171, and the second channel region of each TFT 130 becomes the non-conductive state. The above is a third process.

Then, the detection apparatus is irradiated with the radiation for a predetermined period. The electric signal is accumulated corresponding to the electric charge which is generated according to the radiation with which each pixel is irradiated. Thus, the first conduction voltage Von is sequentially supplied from the first conduction voltage supply unit 171 to each set of the first drive wiring 141 and the second drive wiring 142. Accordingly, the potential Vg11 of the first drive wiring 141 of the first row and the potential Vg12 of the second drive wiring 142 become the first conduction voltage Von, and both of the first channel region and the second channel region of the TFT 130 of the first row become the conductive state. Accordingly, the electric signal accumulated in the pixel 110 of the first row is output to the reading circuit unit 180 via the signal wiring 150 as a parallel electric signal. The operation is sequentially performed in a second row and a third row by the row unit, and the electric signal of the whole pixel array is output. The above is a fourth process.

According to the present exemplary embodiment, the description is given as the conduction voltage supplied from the first conduction voltage supply unit 171 and the conduction voltage supplied from the second conduction voltage supply unit 172 being the same voltage value. However, other configurations may also be contemplated. For example, different voltage values may be applied to each photographing mode or each conduction voltage supply unit. It is desirable that a conduction voltage of a voltage value appropriate for a capacitance value of each channel region is supplied.

According to the present exemplary embodiment, the description is given as the second conduction voltage supply unit 172 being commonly connected to each switch 173 and a predetermined second conduction voltage being supplied. Similar to the first conduction voltage supply unit 171, the second conduction voltage supply unit 172 maybe configured to be able to individually supply the second conduction voltage to each second drive wiring 142 such as a shift resister. Even if such a configuration is provided, in a case where the second connection is selected by the selection unit 174, it is necessary for the second conduction voltage to be supplied to the second drive wiring 142 when the first conduction voltage is supplied to the first drive wiring 141.

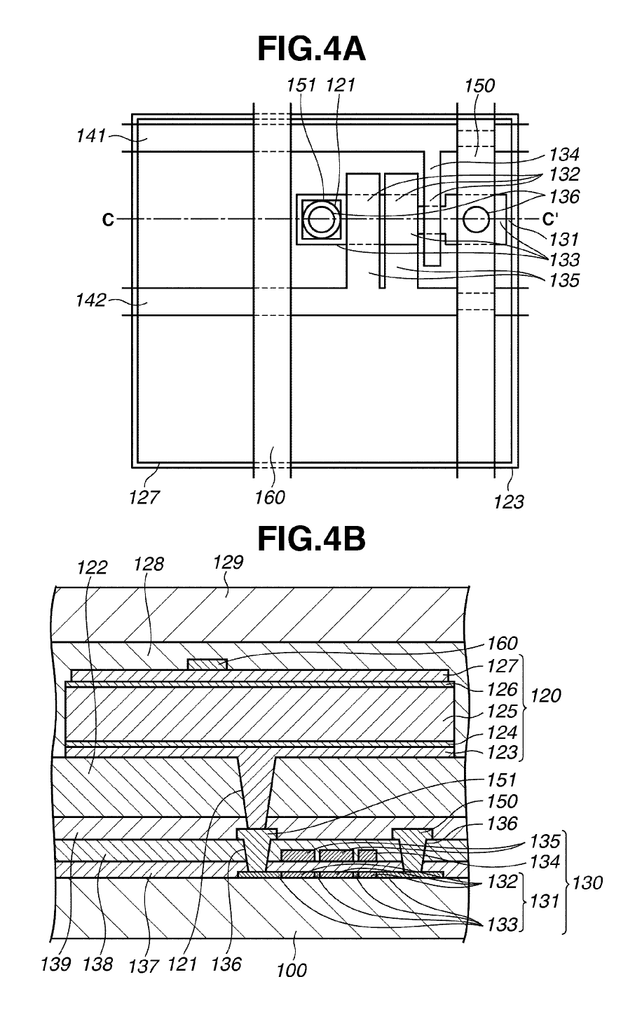

Next, a detection apparatus according to a second exemplary embodiment is described with reference to FIGS. 4A and 4B. FIG. 4A is a plan view of one pixel, and FIG. 4B is a cross-sectional view taken along the line C-C′ in FIG. 4A. Similar members to those which are described in the first exemplary embodiment, are given the same reference numerals and a detailed description thereof is omitted. The TFT 130 according to the present exemplary embodiment is different from the TFT 130 according to the first exemplary embodiment at the following point.

The first gate electrode 134 is provided narrower than the second gate electrode 135 in the width thereof. Thus, the channel length of the first channel region is shorter than that of the second channel region. Thus, the capacitance of the first gate electrode 134 is smaller than that of the second gate electrode 135, so that the capacitance of the first drive wiring 141 is smaller than that of the second drive wiring 142. Accordingly, in the photographing mode in which the second connection is selected by the selection unit 174, the high-speed operability further improves. By decreasing the capacitance of the first channel region, in the photographing mode in which the second connection is selected by the selection unit 174, the capacitance of the signal wiring 150 can be reduced and the S/N ratio further improves.

Next, the channel width of the first channel region is shorter than that of the second channel region. Thus, the capacitance of the first gate electrode 134 and the first channel region are further reduced respectively. In the photographing mode in which the second connection is selected by the selection unit 174, the high-speed operability and the S/N ratio further improve.

A plurality of second gate electrodes 135 is provided (two in the present exemplary embodiment), and thus a plurality of second channel regions is provided (two places in the present exemplary embodiment). According to this configuration, the voltage applied to one of the plurality of the second channel regions is reduced and the leakage current is reduced compared to a configuration including one second channel region. Thus, in the photographing mode in which the first connection is selected by the selection unit 174, the leakage current is further reduced and the S/N ratio further improves.

The first drive wiring 141 and the second drive wiring 142 are thinner (narrower) than the other regions in the width of the wiring, at a region crossing the signal wiring 150. Thus, the capacitance of each drive wiring and the capacitance of the signal wiring 150 are reduced respectively, and the high-speed operability and the S/N ratio further improve.

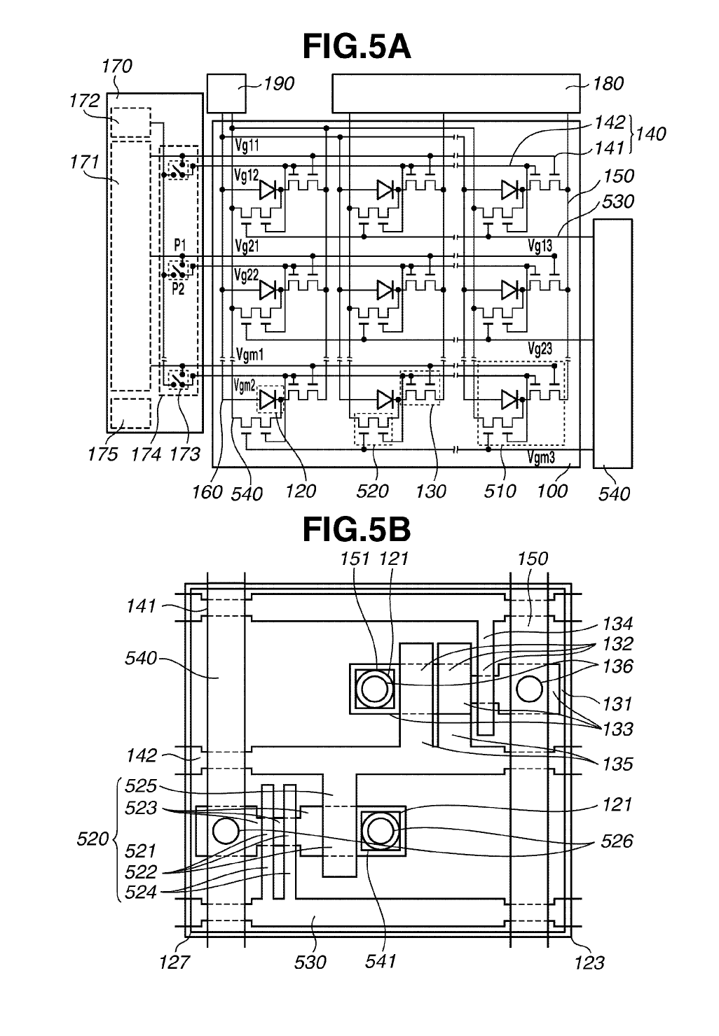

Next, a detection apparatus according to a third exemplary embodiment is described with reference to FIGS. 5A and 5B. FIG. 5A schematically illustrates an equivalent circuit of the detection apparatus according to the present exemplary embodiment, and FIG. 5B illustrates a plan view of one pixel. Similar members to those which are described in the second exemplary embodiment are given the same reference numerals and the detailed description thereof is omitted. The detection apparatus according to the present exemplary embodiment is different from the detection apparatus according to the first exemplary embodiment at the following point.

A pixel 510 further includes a thin film transistor (TFT) 520 for initialization to initialize the conversion element 120 compared to the pixel 110. An impurity semiconductor region 523, which is one of a source and a drain of the TFT 520 for initialization, is electrically connected to the first electrode 123 of the conversion element 120 via a connection electrode 541 in the contact holes 121 and 526 of the TFT 130. The contact hole 526 is provided in the first insulating layer 137 and the second insulating layer 138. The impurity semiconductor region 523, which is connected to the first electrode 123 of the conversion element 120, is referred to as a “third region” or may be referred to as a “third semiconductor region”.

The impurity semiconductor region 523, which is the other of the source and the drain of the TFT 520 for initialization, is electrically connected to a power supply wiring 540 for initialization in the contact holes 526. The impurity semiconductor region 523, which is connected to the power supply wiring 540 for initialization, is considered to be a “fourth region” or a “fourth semiconductor region”. The power supply wiring 540 for initialization is connected to the power supply unit 190. According to the present exemplary embodiment, the power supply unit 190 provides the power supply wiring 540 for initialization with a potential same as the potential which the reading circuit unit 180 provides to the signal wiring 150, and the TFT 520 for initialization has a function of outputting the electric charge that is remained in the conversion element 120 without being output to the TFT 130.

The TFT 520 for initialization includes a semiconductor layer 521 disposed on the insulating substrate 100. The semiconductor layer 521 includes a plurality of channel regions 522 between two impurity semiconductor regions 523 (between the third region and the fourth region). Among the plurality of channel regions 522, a region disposed nearest to the impurity semiconductor region 523 (the fourth region) which is connected to the power supply wiring 540 is defined as a third channel region. A region disposed between the impurity semiconductor regions 523 (the third region) which are connected to the first electrode 123 is defined as a fourth channel region. According to the present exemplary embodiment, as the semiconductor layer 521, a polycrystalline semiconductor layer such as the polycrystalline silicon similar to the TFT 130 is used, and the semiconductor layer 521 also includes the impurity semiconductor region 523.

The TFT 520 for initialization includes a third gate electrode 524 corresponding to the third channel region and a fourth gate electrode 525 corresponding to the fourth channel region via the first insulating layer 137 covering the semiconductor layer 521. In other words, the TFT 520 for initialization is the TFT with the multi-gate structure. By using the TFT with the multi-gate structure, an apparent channel length L of the TFT can be large, and the leakage current at off time can be reduced compared to a TFT with a single-gate structure.

The third gate electrode 524 is connected to a drive wiring 530 for initialization, and the drive wiring 530 for initialization is connected to a driving circuit unit 550 for initialization. The drive wiring 530 for initialization is commonly connected to the third gate electrode 524 of the TFT 520 of the plurality of pixels 110 in the row direction, and is disposed in a plural number (m pieces) in the column direction. The driving circuit unit 550 for initialization supplies the third conduction voltage, which allows the third channel region to be in a conductive state, to the first gate electrode 524 via the drive wiring 530 for initialization. Meanwhile the fourth gate electrode 525 is connected to the second drive wiring 141.

The width of the third gate electrode 524 is formed narrower than that of the fourth gate electrode 525. Thus, the channel length of the third channel region is shorter than that of the fourth channel region. Accordingly, the capacitance of the third gate electrode 524 is smaller than the capacitance of the fourth gate electrode 525, and the capacitance of the drive wiring 540 for initialization is smaller than the capacitance of the second drive wiring 142. Accordingly, in the photographing mode in which the second connection is selected by the selection unit 174, the high-speed operability of the TFT 520 for initialization further improves.

A plurality of third gate electrodes 524 is provided (two in the present exemplary embodiment), and thus a plurality of third channel regions is provided (two places in the present exemplary embodiment). According to this configuration, the voltage applied to one of the plurality of the third channel regions is suppressed and the leakage current can be reduced compared to a configuration including one third channel region. Thus, in the photographing mode in which the second connection is selected by the selection unit 174, the leakage current of the TFT 520 for initialization is further reduced and the S/N ratio further improves. The effect of the reduction of the leakage current becomes higher as difference between the voltage for initialization and the voltage of the conversion element at the time of the reading thereof being increased.

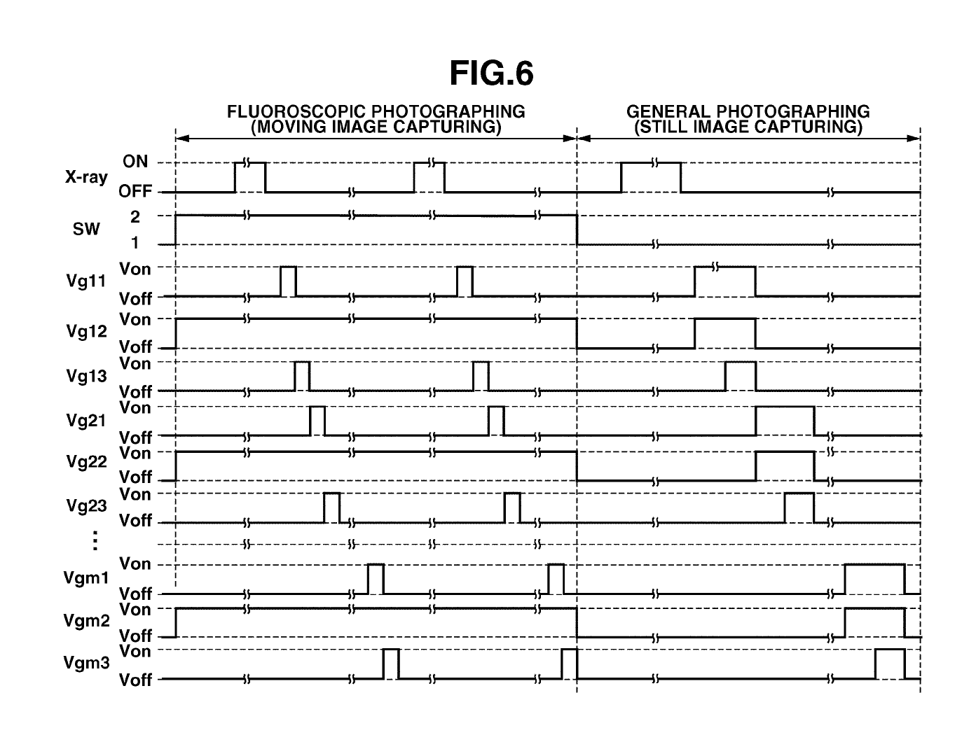

Next, operations of the detection apparatus illustrated in FIGS. 5A and 5B is described with reference to the timing chart of FIG. 6. The description is given as the first conduction voltage, the second conduction voltage, and the third conduction voltage having the same conduction voltage value Von and the same non-conductive voltage value Voff.

First, when the fluoroscopic photographing mode (moving image photographing mode) is selected, the control unit 175 supplies a control signal to the selection unit 174 so that the switch 173 of the selection unit 174 selects the second connection. Accordingly, the switch 173 of the selection unit 174 selects the second connection and starts the supply of the second conduction voltage from the second conduction voltage supply unit 172 to the second drive wiring 142. Then, the potentials Vg12, Vg22, . . . , Vgm2 of each second drive wiring 142 become the second conduction voltage Von, and the second channel region of each TFT 130 and the fourth channel region of each TFT 540 become the conductive state. The above is a first process.

Next, the detection apparatus is irradiated with the radiation for a predetermined period. The electric signal is accumulated corresponding to the electric charge which is generated according to the radiation with which each pixel is irradiated. Thus, the first conduction voltage Von is firstly supplied from the first conduction voltage supply unit 171 to the first drive wiring 141 of the first row. Accordingly, the potential Vg11 of the first drive wiring 141 of the first row becomes the first conduction voltage Von. The first channel region of the TFT 130 of the first row becomes the conductive state in the row unit. Next, the second conduction voltage Von is supplied from the driving circuit unit 550 for initialization to the third drive wiring 530 of the first row. Accordingly, the potential Vg13 of the third drive wiring 530 of the first row becomes the third conduction voltage Von. The third channel region of the TFT 520 of the first row becomes the conductive state in the row unit, and the conversion element 120 is initialized by the TFT 520. The same operation is performed in the second to m-th rows. Thus, the electric signal accumulated in the pixel 110 is sequentially output from the pixel 110 in the row unit to the reading circuit unit 180 in the row unit via the signal wiring 150 as the parallel electric signal. The above is a second process.

In the second process, according to the present exemplary embodiment, the supply of the second conduction voltage from the second conduction voltage supply unit 172 to the second drive wiring 142 is maintained during the fluoroscopic photographing mode (moving image photographing mode). In the fluoroscopic photographing mode (moving image photographing mode), the second process is repeatedly performed several times.

Next, when the general photographing mode (still image photographing mode) is selected, the control unit 175 supplies a control signal to the selection unit 174 so that the switch 173 of the selection unit 174 selects the first connection. Accordingly, the switch 173 of the selection unit 174 selects the first connection. Then, the potentials Vg12, Vg22, . . . , Vgm2 of each second drive wiring 142 become the non-conductive voltage Voff supplied from the first conduction voltage supply unit 171, and the second channel region of each TFT 130 and the fourth channel region of each TFT 520 become the non-conductive state. The above is a third process.

Then, the detection apparatus is irradiated with the radiation for a predetermined period. The electric signal is accumulated corresponding to the electric charge which is generated according to the radiation with which each pixel is irradiated. Thus, the first conduction voltage Von is sequentially supplied from the first conduction voltage supply unit 171 to each set of the first drive wiring 141 and the second drive wiring 142. Accordingly, the potential Vg11 of the first drive wiring 141 of the first row and the potential Vg12 of the second drive wiring 142 become the first conduction voltage Von, and both of the first channel region and the second channel region of the TFT 130 of the first row become the conductive state. Accordingly, the electric signal accumulated in the pixel 110 of the first row is output to the reading circuit unit 180 via the signal wiring 150 as a parallel electric signal. At this time, the fourth channel region of the TFT 540 also becomes the conductive state. Next, during the potential Vg11 of the first drive wiring 141 and the potential Vg12 of the second drive wiring 142 of the first row are the first conduction voltage Von, the second conduction voltage Von is supplied from the driving circuit unit 550 for initialization to the third drive wiring 530 of the first row. Accordingly, the potential Vg13 of the third drive wiring 530 of the first row becomes the third conduction voltage Von. The third channel region of the TFT 520 of the first row also becomes the conductive state in the row unit, and the conversion element 120 is initialized by the TFT 520. The operation is sequentially performed in a second row and a third row by the row unit, and the electric signal of the whole pixel array is output. The above is a fourth process.

According to the present exemplary embodiment, the polycrystalline silicon TFT with the top gate structure is used as the TFT 520 for initialization. However, an amorphous silicon TFT, an oxide TFT using an oxide semiconductor, and an organic TFT using an organic semiconductor, and other equivalent structures may also be used. In any case, it is desirable that the configuration will be the same as the TFT 130.

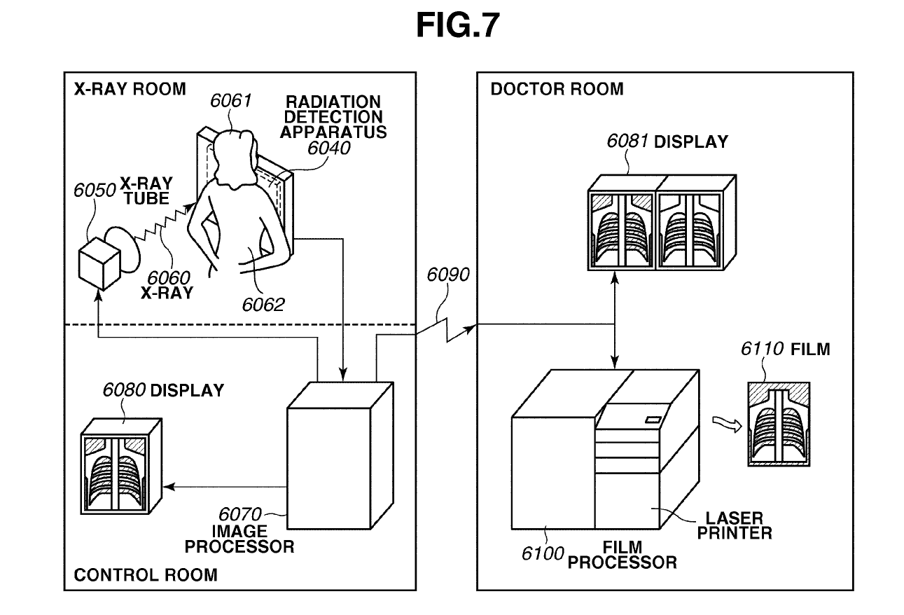

Next, a radiation detection system using the detection apparatus according to any of the above-described embodiments is described with reference to FIG. 7.

In FIG. 7, an X-ray 6060 generated in an X-ray tube 6050 serving as a radiation source penetrates a body part 6062 of a subject 6061, that is a patient, and is incident on each conversion element of a conversion unit included in a radiation detection apparatus 6040. The incident X-ray includes information in the body of the patient 6061. The radiation is converted into an electric charge at the conversion unit 3 corresponding to the X-ray which is incident, and electrical information is obtained. The information is converted into digital data and is subjected to image processing by an image processor 6070 (e.g., a programmed computer) serving as a signal processing unit. The information can be observed at a display 6080 serving as a display unit in a control room.

Further, the information can be transmitted to a remote location by a transmission processing unit via a transmission network (such as a telephone line) 6090. The information can be displayed on a display 6081 serving as a remote display unit or can be stored in a recording unit such as an optical disk in a doctor room of another place. In addition, a doctor of the distance place can diagnose. The information can be recorded in a film 6110 as a recording medium by a film processor 6100 serving as a recording unit.

While the above-described exemplary embodiments will enable a person of ordinary skill in the art to practice any and all of the below listed claims, it is to be understood that the scope of the present invention is not limited to the disclosed exemplary embodiments. The scope of the following claims is to be accorded the broadest interpretation so as to encompass all modifications, equivalent structures, and functions.

This application claims priority from Japanese Patent Application No. 2011-207348 filed Sep. 22, 2011, which is hereby incorporated by reference herein in its entirety.

What is claimed is:

1. A detection apparatus comprising:
a conversion element configured to convert radiation or light into an electric charge;
a transistor configured to output an electric signal to a signal wiring according to the electric charge, the transistor including a first region connected to the conversion element, a second region connected to the signal wiring, a first channel region disposed between the first region and the second region, a second channel region disposed between the first region and the first channel region, a first gate electrode which corresponds to the first channel region, and a second gate electrode which corresponds to the second channel region;
a first drive wiring connected to the first gate electrode;
a second drive wiring connected to the second gate electrode;
a first conduction voltage supply unit configured to supply a first conduction voltage allowing the first channel region to be in a conductive state to the first driving wiring;
a second conduction voltage supply unit configured to supply a second conduction voltage allowing the second channel region to be in a conductive state to the second driving wiring; and
a selection unit configured to select any one of a first connection between the second drive wiring and the first conduction voltage supply unit and a second connection between the second drive wiring and the second conduction voltage supply unit.

2. The detection apparatus according to claim 1, further comprising a control unit configured to control the selection unit,
wherein the control unit controls the selection unit to select the second connection in a first photographing mode among a plurality of photographing modes, and select the first connection in a second photographing mode among the plurality of photographing modes, and
wherein, an operating speed of the transistor is higher in the second photographing mode than in the first photographing mode.

3. The detection apparatus according to claim 2, wherein, in the second photographing mode, the first conduction voltage supply unit supplies the first conduction voltage to the first gate electrode in a state in which the second conduction voltage is supplied to the second gate electrode by the second conduction voltage supply unit.

4. The detection apparatus according to claim 3, wherein a width of the first gate electrode is narrower than a width of the second gate electrode, and a length of the first channel region is shorter than a length of the second channel region.

5. The detection apparatus according to claim 3, wherein a plurality of the second gate electrode are provided, and a plurality of the second channel regions are provided.

6. The detection apparatus according to claim 1,
wherein a plurality of pixels, each of which includes the conversion element and the transistor, is disposed on a substrate and arranged in a matrix of rows and columns,
the conversion element is disposed on the substrate,
the transistor is a thin film transistor which is disposed between the substrate and the conversion element, and
the thin film transistor includes a semiconductor layer including the first channel region, the second channel region, the first region, and the second region, and the semiconductor layer is a polycrystalline semiconductor layer.

7. The detection apparatus according to claim 6,
wherein the pixel further includes a thin film transistor for initialization connected to a power supply wiring for initialization the conversion element,
the thin film transistor for initialization includes a semiconductor layer including a third channel region which is disposed between a third region connected to the conversion element and a fourth region which is connected to the power supply wiring and a fourth channel region which is disposed between the third region and the third channel region, a third gate electrode which corresponds to the third channel region, and a fourth gate electrode which is provided corresponding to the fourth channel region.

8. The detection apparatus according to claim 7, wherein a width of the third gate electrode is narrower than a width of the fourth gate electrode.

9. The detection apparatus according to claim 7, wherein a plurality of the third gate electrodes are provided, and a plurality of the third channel regions are provided.

10. A detection system comprising:
a detection apparatus according to claim 1;
a signal processing unit configured to process a signal from the detection apparatus;
a recording unit configured to record the signal from the signal processing unit;
a display unit configured to display the signal from the signal processing unit; and
a transmission processing unit configured to transmit the signal from the signal processing unit.
